(19) United States
(12) Patent Application Publication
(10) Pub. No.: US 2026/0175376 A1
(43) Pub. Date: Jun. 25, 2026

(54) CLAMPING DEVICE

(71) Applicant: Nanjing Chervon Industry Co., Ltd., Nanjing (CN)

(72) Inventors: Yuyi Zheng, Nanjing (CN); Xu Wang, Nanjing (CN); Haonan Du, Nanjing (CN)

(21) Appl. No.: 19/223,483

(22) Filed: May 30, 2025

(30) Foreign Application Priority Data
Dec. 25, 2024 (CN) 202411927363.X

(51) Int. Cl. B25B 23/00; B25B 21/02

(52) U.S. Cl. CPC B25B 23/0035; B25B 21/02

(57) ABSTRACT

A clamping device includes a shaft body having an axial opening, extending along a first straight line, and a hole; a retainer configured to move within the hole; a sleeve sleeved on the outer circumference of the shaft body and configured to move axially relative to the shaft body; an abutting member abutting against the rear side of the retainer; a first elastic member located on the front side of the retainer; and a second elastic member located on the rear side of the retainer and being in contact with the abutting member. The sleeve includes a protrusion that extends along a second straight line and that abuts against the shaft body where the second straight line intersects the first straight line. Along the direction of the first straight line, the protrusion is located at the front end of the retainer and is not in contact with the retainer.

### RELATED APPLICATION INFORMATION

This application claims the benefit under 35 U.S.C. § 119(a) of Chinese Patent Application No. CN 202411927363.X, filed on Dec. 25, 2024, which application is incorporated herein by reference in its entirety.

### TECHNICAL FIELD

The present application relates to the technical field of power tools and, in particular, to a clamping device.

### BACKGROUND

Handheld power tools play a very important role in daily production and life. The electric drill and the impact drill may be equipped with drill bits of different diameters to drill holes in objects. The impact wrench is used for tightening bolts and nuts. The impact screwdriver is usually used for loosening or tightening screws. The angle grinder can grind and cut objects.

During operation, a power tool with a clamping device needs to be equipped with different bits to adapt to different types of screws. Therefore, this type of power tool usually has the function of quickly replacing the bit. The clamping device includes a sphere and an external sleeve mating with the sphere to achieve quick bit replacement. However, in the existing art, during the bit replacement process or after the bit replacement is completed, the cooperation between the external sleeve and the sphere is relatively unstable, and it is difficult to ensure the stability of the clamping device in clamping the bit.

This part provides background information related to the present application, and the background information is not necessarily the existing art.

### SUMMARY

An object of the present application is to solve or at least alleviate part or all of the preceding problems. Therefore, an object of the present application is to provide a clamping device with good stability and high reliability.

To achieve the preceding object, the present application adopts the technical solutions below.

A clamping device includes a shaft body, at least one retainer, a sleeve, an abutting member, a first elastic member, and a second elastic member.

The shaft body includes an axial opening for accommodating a working accessory and at least one hole disposed around a circumferential wall of the axial opening, where the axial opening extends along a first straight line.

Each of the at least one retainer is configured to move within a respective hole of the at least one hole.

The sleeve is sleeved on the outer circumference of the shaft body and configured to move axially relative to the shaft body.

The abutting member abuts against the rear side of the at least one retainer.

The first elastic member is disposed inside the sleeve and located on the front side of the at least one retainer.

The second elastic member is disposed inside the sleeve, located on the rear side of the at least one retainer, and in contact with the abutting member.

The sleeve includes a protrusion extending along a second straight line, and the protrusion abuts against the shaft body, where the second straight line intersects with the first straight line; and along the direction of the first straight line, the protrusion is located at the front end of the at least one retainer and is not in contact with the at least one retainer.

In some examples, the abutting member extends along a third straight line, where the third straight line intersects with the first straight line.

In some examples, the sleeve includes a stop portion, the stop portion includes an inclined surface and a horizontal surface, and when the working accessory is not inserted into the axial opening, the horizontal surface abuts against the at least one retainer.

In some examples, when the working accessory is inserted into the axial opening, the at least one retainer presses the inclined surface and the second elastic member.

In some examples, the working accessory includes at least one accessory groove, and each of the at least one accessory groove matches a respective retainer of the at least one retainer, where after the working accessory is fully inserted into the axial opening, each of the at least one accessory groove corresponds to a respective hole of the at least one hole, and each of the at least one retainer is pushed to a position between a respective accessory groove of the at least one accessory groove and the horizontal plane based on an elastic force of the second elastic member.

In some examples, when the sleeve is pulled axially, the protrusion compresses the first elastic member so that the working accessory is capable of being pulled out of the axial opening.

In some examples, the clamping device further includes a limiting portion, where the limiting portion is disposed between the sleeve and the shaft body and located at the front end of the protrusion, and the first elastic member is disposed between the protrusion and the limiting portion.

In some examples, the clamping device further includes a third elastic member disposed inside the shaft body, where when the working accessory is inserted into the axial opening, the working accessory compresses the third elastic member.

In some examples, when the sleeve is pulled axially, the third elastic member applies an elastic force to the working accessory so that the working accessory is moved away from the third elastic member, and the working accessory is capable of being moved out of the axial opening.

In some examples, when the rear diameter of the shaft body is less than the inner diameter of the sleeve, the clamping device further includes a positioning component, and the positioning component is sleeved on the shaft body.

In some examples, the inner diameter of the second elastic member is greater than the inner diameter of the positioning component.

In some examples, the sleeve includes an end in contact with the positioning component along the direction of the first straight line.

In some examples, each of the at least one retainer is a sphere.

In some examples, along the direction of the first straight line, the axial length of the sleeve is greater than or equal to 13 mm and less than or equal to 20 mm.

In some examples, the sleeve and the shaft body are non-fixedly connected, and the circumferential surface of the sleeve is smooth and has no holes.

In some examples, a clamping device includes a shaft body, at least one retainer, a sleeve, a first elastic member, and a second elastic member.

The shaft body includes an axial opening for accommodating a working accessory and at least one hole disposed around a circumferential wall of the axial opening, where the axial opening extends along a first straight line.

Each of the at least one retainer is configured to move within a respective hole of the at least one hole.

The sleeve is sleeved on the outer circumference of the shaft body and configured to move axially relative to the shaft body.

The first elastic member is disposed inside the sleeve and located on the front side of the at least one retainer.

The second elastic member is disposed inside the sleeve and located on the rear side of the at least one retainer.

The sleeve includes a protrusion extending along a second straight line, and the protrusion is located at the front end of the at least one hole and is in contact with the shaft body, where the second straight line intersects with the first straight line, and the protrusion is not in contact with the at least one retainer along a circumferential circle around the shaft body.

In some examples, a clamping device includes a shaft body, at least one retainer, a sleeve, a first elastic member, and a second elastic member.

The shaft body includes an axial opening for accommodating a working accessory and at least one hole disposed around a circumferential wall of the axial opening, where the axial opening extends along a first straight line.

Each of the at least one retainer is configured to move within a respective hole of the at least one hole.

The sleeve is sleeved on the outer circumference of the shaft body and configured to move axially relative to the shaft body.

The first elastic member is disposed inside the sleeve and located on the front side of the at least one retainer.

The second elastic member is disposed inside the sleeve and located on the rear side of the at least one retainer.

The sleeve includes a protrusion extending along a second straight line, the protrusion is in contact with the shaft body, and no overlapping portion exists between the projection of the protrusion and the projection of the at least one hole on an axial plane, where the second straight line intersects with the first straight line.

In some examples, the projections of the at least one retainer and the at least one hole on the axial plane coincide.

In some examples, the clamping device further includes an abutting member abutting against the rear side of the at least one retainer, where the abutting member extends along a third straight line, the third straight line intersects with the first straight line, and the second elastic member abuts against the abutting member.

In some examples, the sleeve includes a stop portion, the stop portion includes an inclined surface and a horizontal surface, and when the working accessory is inserted into the axial opening, the horizontal surface mates with the at least one retainer to prevent the working accessory to move.

The present application has the benefits below. The protrusion can relatively stably abut against the shaft body, that is, the sleeve can always stably abut against the shaft body based on the protrusion even when the sleeve moves axially relative to the shaft body. The problem in the existing art that the sleeve is unstable due to the inability to abut against the shaft body caused by the contact between the sleeve and the retainers is solved so that the stability of the clamping device in the present application can be ensured and the reliability is relatively high.

### BRIEF DESCRIPTION OF THE DRAWINGS

FIG. 1 is a side view of an impact screwdriver according to an example.

FIG. 2 is a side sectional view of the impact screwdriver in FIG. 1.

FIG. 3 is a side sectional view illustrating that the impact screwdriver in FIG. 2 includes an impact mechanism.

FIG. 4 is a perspective view of a clamping device according to an example.

FIG. 5 is an exploded view of the clamping device in FIG. 4.

FIG. 6 is a side sectional view of the clamping device in FIG. 4.

FIG. 7 is a partial enlarged view of FIG. 6.

FIG. 8 is a side sectional view illustrating the process of inserting a working accessory into the clamping device in FIG. 4.

FIG. 9 is a side sectional view illustrating the process of pulling a working accessory out of the clamping device in FIG. 4.

FIG. 10 is a side sectional view illustrating that a clamping device includes a positioning component according to an example.

FIG. 11 is a side sectional view illustrating that a clamping device includes a third elastic member according to an example.

FIG. 12 is a side sectional view illustrating the process of inserting a working accessory into the clamping device in FIG. 11.

FIG. 13 is an exploded view illustrating that a clamping device includes only one elastic member according to an example.

FIG. 14 is a side sectional view of the clamping device in FIG. 13.

FIG. 15 is a side sectional view of the clamping device in FIG. 13 without a second sleeve.

FIG. 16A is a perspective view illustrating that an abutting member has a split structure according to an example.

FIG. 16B is a perspective view illustrating that an abutting member includes a chamfer according to an example.

FIG. 16C is a perspective view illustrating that an abutting member includes a guide structure and ball grooves according to an example.

FIG. 17 is an exploded view illustrating that a clamping device includes a third retainer according to an example.

FIG. 18 is a side view of the clamping device in FIG. 17 with a sleeve removed.

FIG. 19A is a side sectional view illustrating that the clamping device in FIG. 17 into which a working accessory is inserted includes a first retainer and a second retainer.

FIG. 19B is a side sectional view illustrating that the clamping device in FIG. 17 into which a working accessory is inserted includes a third retainer.

FIG. 20A is a side sectional view illustrating that the clamping device in FIG. 17 out of which a working accessory is pulled includes a first retainer and a second retainer.

FIG. 20B is a side sectional view illustrating that the clamping device in FIG. 17 out of which a working accessory is pulled includes a third retainer.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies,one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

Handheld power tools play a very important role in daily production and life. The handheld power tools include, but are not limited to, an electric hand drill, an impact drill, an impact wrench, an impact screwdriver, and an angle grinder. It is to be understood that in other alternative examples, different working accessories may be mounted to a handheld power tool. The handheld power tool with one of these different working accessories may be the impact drill or the impact screwdriver.

The present application provides a power tool, specifically an impact screwdriver. It is to be understood that any power tool having an output shaft and a working accessory attached to the output shaft can adopt the technical solutions disclosed in this example, and any power tools adopting the technical solutions disclosed in this example are within the scope of the present application.

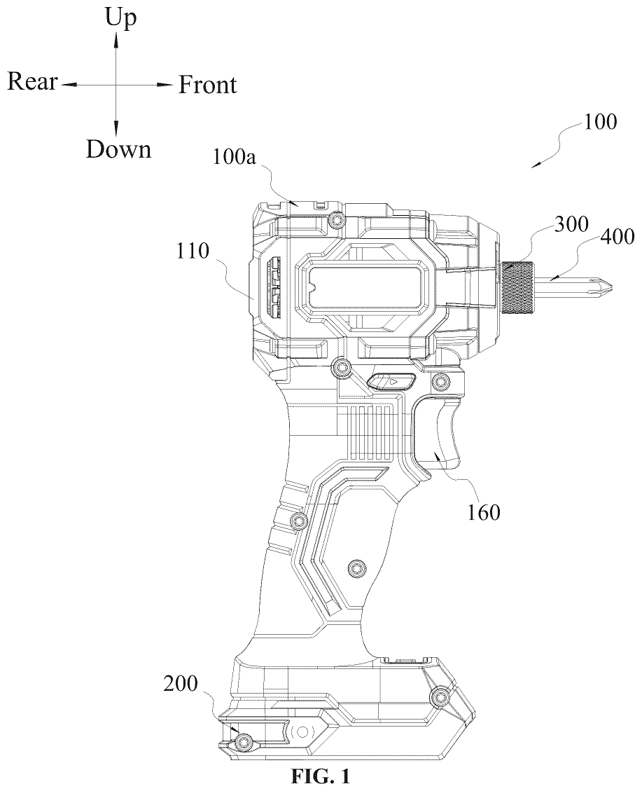

To clearly illustrate the technical solutions of the present application, an upper side, a lower side, a front side, and a rear side shown in FIG. 1 are further defined.

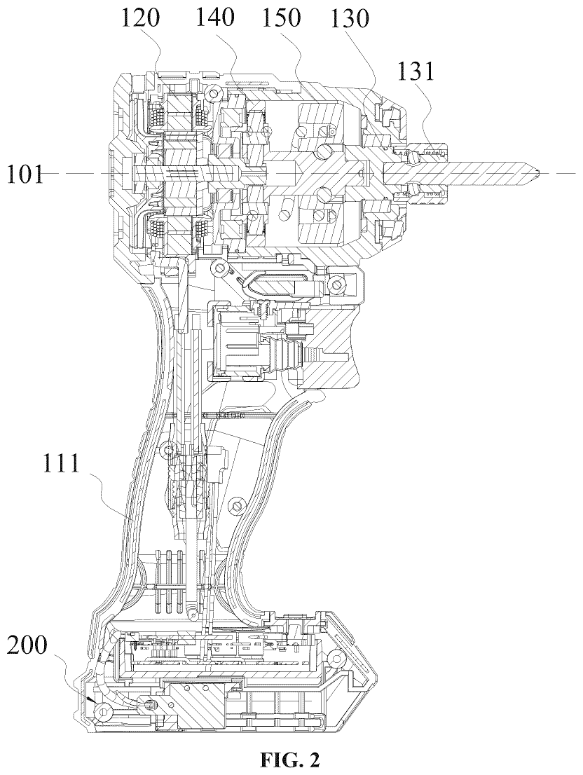

As shown in FIGS. 1 and 2, an impact screwdriver 100 includes a tool body 100a and a clamping device 300 connected to the tool body 100a. A working accessory 400 is used for implementing the function of the impact screwdriver 100 and detachably connected to the impact screwdriver 100.

The impact screwdriver 100 further includes a power supply device 200. The power supply device 200 is used for supplying electrical energy to the impact screwdriver 100. In this example, the power supply device 200 is a battery pack, and the battery pack mates with a corresponding power circuit to supply power to corresponding components in the impact screwdriver 100. It is to be understood by those skilled in the art that the power supply device 200 is not limited to the battery pack and may supply power to the corresponding components in the impact screwdriver 100 through mains power or an alternating current power supply in conjunction with corresponding rectifier, filter, and voltage regulator circuits.

The tool body 100a includes a housing 110, an electric motor 120, an output mechanism 130, a transmission mechanism 140, an impact mechanism 150, and a switch 160. The housing 110 includes a motor housing for accommodating the electric motor 120 and an output housing for accommodating at least part of the output mechanism 130. The output housing is connected to the front end of the motor housing. The housing 110 is further formed with or connected to a grip 111 for a user to operate. The grip 111 and the motor housing form a T-shaped or L-shaped structure, which is convenient for the user to hold and operate. The power supply device 200 is connected to an end of the grip 111. The power supply device 200 is detachably connected to the grip 111.

The electric motor 120 includes a motor shaft rotating about a motor axis 101.

The output mechanism 130 includes an output shaft 131 connected to the working accessory 400 and used for driving the working accessory 400 to rotate. The output shaft 131 is used for outputting power and rotates about an output axis. In this example, the motor axis 101 coincides with the output axis. In other alternative examples, the motor axis 101 is parallel to but does not coincide with the output axis, or the motor axis 101 intersects with the output axis.

The transmission mechanism 140 is disposed between the electric motor 120 and the impact mechanism 150 and used for transmitting power between the motor shaft and the impact mechanism 150. In this example, the transmission mechanism 140 is a first-stage gear reduction mechanism.

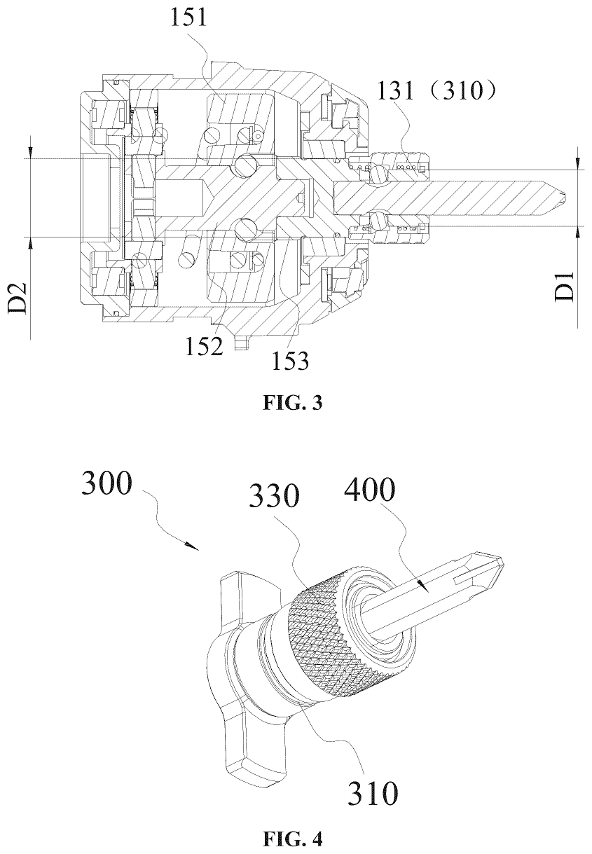

The impact mechanism 150 is used for supplying an impact force to the output shaft 131. Referring to FIG. 3, the impact mechanism 150 includes a main shaft 151, an impact hammer 152, and a hammer anvil 153. The output shaft 131 is connected to the hammer anvil 153. It is to be understood that the hammer anvil 153 and the output shaft 131 may be integrally formed or separately formed as independent parts. The output shaft 131 is rotatable about the output axis. The output shaft 131 is used for outputting power. The working principle of a mechanical impact mechanism and the impact generated by the impact mechanism have been fully disclosed to those skilled in the art. Therefore, a detailed description is omitted here for brevity of description.

The switch 160 is a trigger switch. The trigger switch is disposed on the grip 111 to be operated by the user to control the impact screwdriver 100 to be switched on or off.

The specific structure of the clamping device 300 is described in detail below.

As shown in FIGS. 4 to 6, the clamping device 300 includes a shaft body 310, retainers 320, a sleeve 330, elastic members 340, an abutting member 350, and a limiting portion 360. The shaft body 310 is the output shaft 131, and the shaft body 310 is used for the description of the following text of the present application.

The shaft body 310 is formed with an axial opening 311 and at least one hole 312. The axial opening 311 is an opening facing the front end of the impact screwdriver 100 and is used for accommodating the working accessory 400. The axial opening 311 extends along a first straight line. The first straight line is an axis extending along the front and rear direction of the impact screwdriver 100. In this example, the first straight line is the motor axis 101. The first straight line 101 is used for a specific description of the following text of the present application. As shown in FIG. 6, the case where two holes 312 are provided is used as an example for a specific description of the present application. The two holes 312 are arranged along the circumferential wall of the axial opening 311, and the two holes 312 are equal in size. In the front and rear direction, the two holes 312 are disposed at the same position, that is, in the up and down direction, the two holes 312 are symmetrically provided. In the present application, the two holes 312 are elliptical holes. In addition, the holes 312 may also be circular holes, which are not limited in the present application.

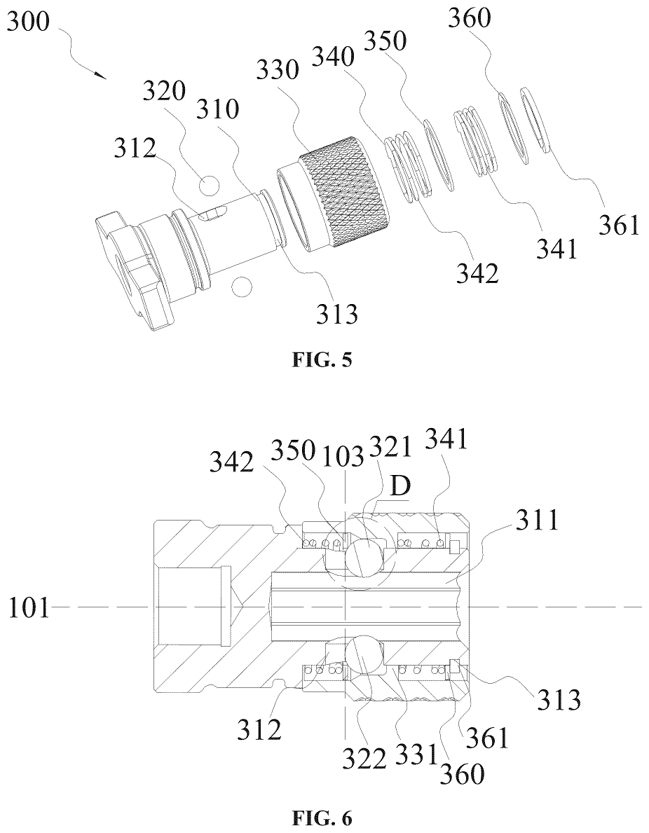

At least one retainer 320 is provided. As shown in FIG. 5, the case where two retainers 320 are provided is used as an example for a specific description. The retainers 320 include a first retainer 321 and a second retainer 322, and each of the first retainer 321 and the second retainer 322 is configured to move in a respective hole 312. The retainers 320 are spheres, and the first retainer 321 and the second retainer 322 are spheres of equal size and volume. In the front and rear direction, the length of the hole 312 is greater than the diameter of the first retainer 321 so that the first retainer 321 and the second retainer 322 can move in the holes 312. In the up and down direction, the first retainer 321 and the second retainer 322 include portions protruding from the holes 312. Since the first retainer 321 and the second retainer 322 are symmetrically provided and the two retainers are equal in size and volume, the mating structure and function implementation method of the first retainer 321 are the same as those of the second retainer 322. Therefore, the first retainer 321 is used as an example for a specific description below.

The sleeve 330 is sleeved on the outer circumference of the shaft body 310 and wraps around the shaft body 310. The sleeve 330 is axially movable in the front and rear direction relative to the shaft body 310.

The elastic members 340 include a first elastic member 341 and a second elastic member 342, both of which are disposed inside the sleeve 330. In the up and down direction, the first elastic member 341 and the second elastic member 342 are disposed between the shaft body 310 and the sleeve 330. The first elastic member 341 is located on the front side of the retainers 320, and the second elastic member 342 is located on the rear side of the retainers 320. That is, in the front and rear direction, the first elastic member 341 is located on the front side of the first retainer 321, and the second elastic member 342 is located on the rear side of the first retainer 321. The present application does not limit the first elastic member 341 and the second elastic member 342. The first elastic member 341 and the second elastic member 342 may be the same or different.

The abutting member 350 is sleeved around the outer circumference of the shaft body 310, located between the shaft body 310 and the sleeve 330, and in contact with the second elastic member 342. Optionally, the second elastic member 342 and the abutting member 350 may be fixedly connected. Optionally, the second elastic member 342 and the abutting member 350 may be in an abutting relationship, and the second elastic member 342 abuts against the abutting member 350. Moreover, the abutting member 350 is located on the outer side of the hole 312, that is, in the up and down direction, the abutting member 350 is located on the upper side or lower side of the hole 312, excluding the portion extending to the inner side of the hole 312. The abutting member 350 extends along a third straight line 103, and the third straight line 103 intersects with the first straight line 101. The present application does not limit the angle at which the third straight line 103 intersects with the first straight line 101, and the angle between the third straight line 103 and the first straight line 101 may be 30 degrees, 60 degrees, 72 degrees, 90 degrees, or the like. When the included angle between the third straight line 103 and the first straight line 101 is 90 degrees, the space occupied by the abutting member 350 in the front and rear direction is the smallest so that the axial length of the clamping device 300 is relatively short.

As shown in FIG. 6, the case where the third straight line 103 is perpendicular to the first straight line 101 is used as an example for a specific description of the present application. The abutting member 350 has a ring structure, and the abutting member 350 extends in the up and down direction and includes two parallel circumferential surfaces in the front and rear direction. The abutting member 350 is located behind the first retainer 321 and abuts against the rear side of the first retainer 321. In addition, since many cases regarding the angle between the third straight line 103 and the first straight line 101 exist, the abutting member 350 may have other structures besides two parallel ring structures (that is, the side view of the ring in FIG. 6 shows a rectangle). For example, the abutting member 350 may be a ring whose side view shows a right trapezoid or may be a ring whose side view shows a parallelogram, which is not limited in the present application.

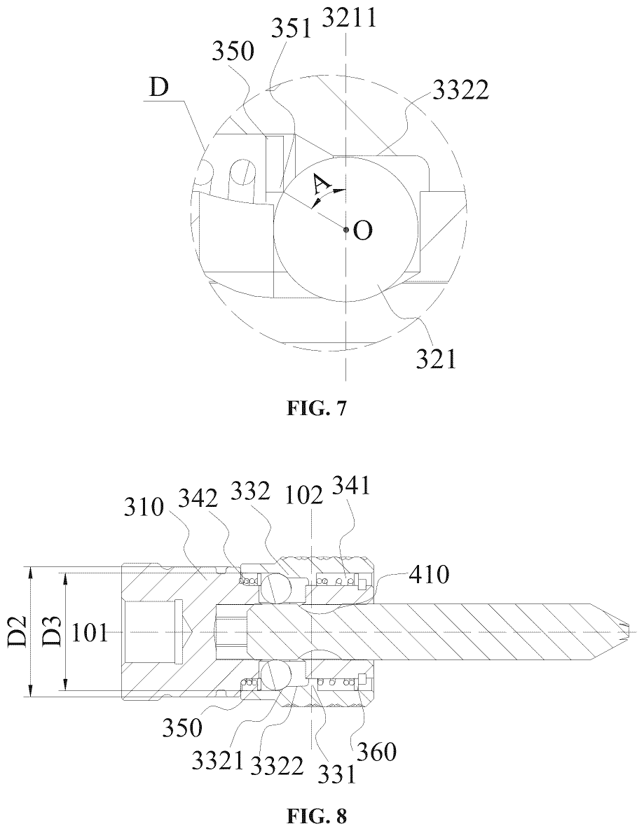

As shown in FIG. 7, the portion of the abutting member 350 that abuts against the first retainer 321 is an abutting corner portion 351, and the abutting corner portion 351 always applies a force to the first retainer 321. The force applied by the abutting corner portion 351 to the first retainer 321 may be decomposed into a force in a horizontal direction (that is, the front and rear direction) and a force in a vertical direction (that is, the up and down direction) so that when the abutting member 350 abuts against the first retainer 321 and makes the first retainer 321 move, the abutting member 350 can not only push the first retainer 321 to move forward and backward but also push the first retainer 321 to move upward and downward. The first retainer 321 includes a central axis 3211 extending up and down, and the central axis 3211 passes through the center O of the first retainer 321. The specific case where the abutting member 350 abuts against the rear side of the first retainer 321 is as follows: in the front and rear direction, the abutting corner portion 351 abuts against the rear side portion of the central axis 3211. The line connecting the abutting corner portion 351 and the center O of the first retainer 321 forms an included angle A with the central axis 3211, and the included angle A is greater than or equal to 0 degrees and less than or equal to 90 degrees.

The limiting portion 360 is a ring sleeved around the outer circumference of the shaft body 310 and located between the shaft body 310 and the sleeve 330. The limiting portion 360 is located at the front end of the clamping device 300, in contact with the first elastic member 341, and used for limiting the position of the first elastic member 341. As shown in FIGS. 5 and 6, a groove 313 is provided at the front end of the shaft body 310, the clamping device 300 further includes an annular clamping member 361 matching the groove 313, and the annular clamping member 361 may be clamped and fixed inside the groove 313. The limiting portion 360 is disposed between the first elastic member 341 and the annular clamping member 361, an end of the limiting portion 360 is in contact with the first elastic member 341, and the other end of the limiting portion 360 is in contact with the annular clamping member 361 so that based on the annular clamping member 361, the limiting portion 360 can limit the position of the first elastic member 341.

As shown in FIGS. 6, 8, and 9, the sleeve 330 includes a protrusion 331 extending along a second straight line 102 and abutting against the shaft body 310. The second straight line 102 intersects with the first straight line 101, and the included angle between the second straight line 102 and the first straight line 101 may be 30 degrees, 45 degrees, 55 degrees, 63 degrees, 90 degrees, or the like, which is not limited in the present application. When the included angle between the second straight line 102 and the first straight line 101 is 90 degrees, the space occupied by the protrusion 331 in the front and rear direction is the smallest so that the axial length of the clamping device 300 is relatively short.

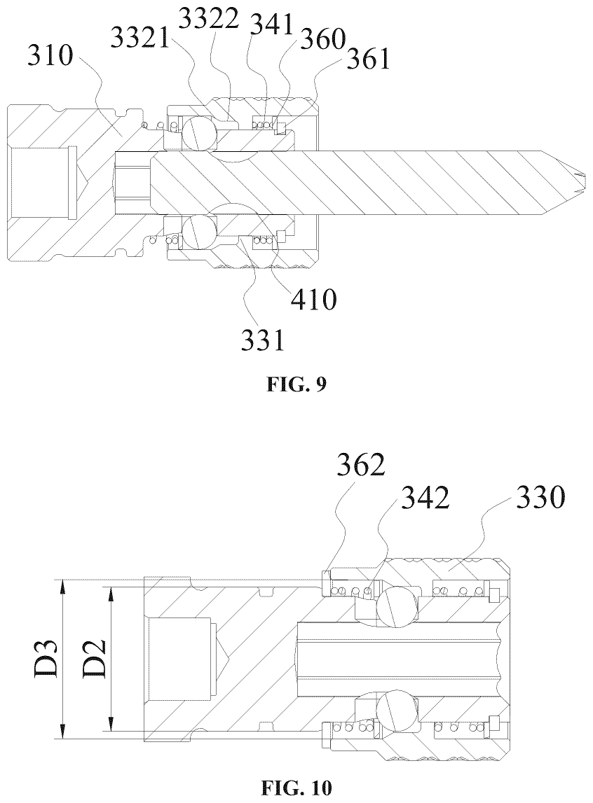

The case where the second straight line 102 is perpendicular to the first straight line 101 as shown in FIGS. 6, 8, and 9 is used as an example for a specific description of the present application. In multiple states where the clamping device 300 has not mated with the working accessory 400 as shown in FIG. 6, the working accessory 400 is inserted into the clamping device 300 as shown in FIG. 8, and the working accessory 400 is pulled out of the clamping device 300 as shown in FIG. 9, in the direction of the first straight line 101, the protrusion 331 is always located at the front ends of the first retainer 321 and the second retainer 322 and abuts against the shaft body 310, and the protrusion 331 is always not in contact with the first retainer 321 and the second retainer 322. That is, the protrusion 331 is always in contact with the shaft body 310 and is not in contact with the first retainer 321 and the second retainer 322 along a circumferential circle around the shaft body 310. The circumference on which the protrusion 331 is located and the circumference on which the first retainer 321 and the second retainer 322 are located are always different. Since the first retainer 321 and the second retainer 322 are always located in the holes 312, the projections of the first retainer 321, the second retainer 322, and the holes 312 on the axial plane coincide. Specifically, the projections of the first retainer 321 and the second retainer 322 on the axial plane are covered by the projections of the holes 312 on the axial plane. The protrusion 331 is always not in contact with the first retainer 321 and the second retainer 322 so that no overlapping portion exists between the projection of the protrusion 331 and the projections of the holes 312 on the axial plane. The axial plane is a horizontal plane extending along the front and rear direction.

Therefore, the protrusion 331 can relatively stably abut against the shaft body 310, that is, the sleeve 330 can always stably abut against the shaft body 310 based on the protrusion 331 even when the sleeve 330 moves axially relative to the shaft body 310. The problem in the existing art that the sleeve is unstable due to the inability to abut against the shaft body caused by the contact between the sleeve and the retainers is solved so that the stability of the clamping device 300 in the present application can be ensured and the reliability is relatively high.

In some examples, as shown in FIGS. 7, 8, and 9, the sleeve 330 further includes a stop portion 332, and the stop portion 332 includes an inclined surface 3321 and a horizontal surface 3322. When the clamping device 300 has not mated with the working accessory 400, that is, the working accessory 400 is not inserted into the axial opening 311, the horizontal surface 3322 abuts against the first retainer 321, and the horizontal surface 3322 mates with the hole 312 to prevent the first retainer 321 from moving. After the working accessory 400 is fully inserted into the axial opening 311, the horizontal surface 3322 abuts against the first retainer 321 again, and the horizontal surface 3322 mates with the hole 312 to prevent the first retainer 321 from moving, thereby preventing the working accessory 400 from moving, ensuring that the working accessory 400 can be stably clamped after being inserted into the clamping device 300, and avoiding the following: the working accessory 400 becomes loose or detached due to unstable clamping during the use of the impact screwdriver 100.

FIG. 8 is a schematic view illustrating that the working accessory 400 is inserted into the axial opening 311. The process of inserting the working accessory 400 into the clamping device 300 is described in detail below. The working accessory 400 includes accessory grooves 410 that match the retainers 320. The case where two accessory grooves 410 match the first retainer 321 and the second retainer 322, respectively is used as an example for a specific description of the present application.

During the process of inserting the working accessory 400 into the axial opening 311, first, the working accessory 400 abuts against the first retainer 321 and the second retainer 322 toward the outside so that the first retainer 321 and the second retainer 322 are pressed and moved from the horizontal plane 3322 to the inclined plane 3321 in the axial direction. Moreover, during the process of being pressed and moved to the inclined plane 3321, the first retainer 321 and the second retainer 322 are pressed outward in the radial direction, the first retainer 321 is pressed and moved upward away from the hole 312, and the second retainer 322 is pressed and moved downward away from the hole 312. Next, when the working accessory 400 gradually moves toward the inside of the axial opening 311, the first retainer 321 and the second retainer 322 further press the inclined surface 3321 and the abutting member 350, that is, further press the inclined surface 3321 and the second elastic member 342, so that the second elastic member 342 is compressed. Finally, after the working accessory 400 is fully inserted into the axial opening 311, the two accessory grooves 410 correspond to the two holes 312, respectively, the first retainer 321 and the second retainer 322 can no longer press the inclined surface 3321 and the second elastic member 342 based on the working accessory 400, the second elastic member 342 is released back to its original position, each of the first retainer 321 and the second retainer 322 is pushed to the right side to a position between the accessory groove 410 (or the hole 312) and the horizontal plane 3322 based on the elastic force of the second elastic member 342, and the first retainer 321 and the second retainer 322 fix the working accessory 400 inside the clamping device 300.

FIG. 9 is a schematic view illustrating that the working accessory 400 is pulled out of the axial opening 311. The process of pulling the working accessory 400 out of the clamping device 300 is described in detail below.

During the process of pulling the working accessory 400 out of the axial opening 311, first, the sleeve 330 needs to be pulled axially. Specifically, the sleeve 330 needs to be pulled axially to the right. In this case, the protrusion 331 presses the first elastic member 341 to the right, and the first elastic member 341 is located between the protrusion 331 and the limiting portion 360 and is compressed. Moreover, since the sleeve 330 moves to the right, the contact portion between the first retainer 321 and the sleeve 330 and the contact portion between the second retainer 322 and the sleeve 330 change from the horizontal plane 3322 to the plane behind the inclined plane 3321 so that in the up and down direction, each of the first retainer 321 and the second retainer 322 is in a loose space between the sleeve 330 and the accessory groove 410 and is no longer pressed and fixed. Next, since each of the first retainer 321 and the second retainer 322 is no longer fixed between the sleeve 330 and the accessory groove 410, the working accessory 400 may be pulled so that the working accessory 400 can be pulled out of the axial opening 311. Finally, after the working accessory 400 is pulled out, the sleeve 330 is released, the first elastic member 341 is released back to its original position, and the sleeve 330 is pushed to the left based on the elastic force of the first elastic member 341 so that the sleeve 330 also returns to its original position.

The shaft body 310 has a front diameter D1 and a rear diameter D2. As shown in FIG. 3, the front diameter D1 refers to the diameter of the portion of the shaft body 310 on which the first elastic member 341 and the second elastic member 342 are sleeved, and the rear diameter D2 refers to the diameter of the portion connected to the housing 110 of the impact screwdriver 100. The rear diameter D2 may change.

In some examples, as shown in FIGS. 8 and 9, when the rear diameter D2 is greater than the inner diameter D3 of the sleeve 330, the sleeve 330 includes an end in contact with the shaft body 310 along the direction of the first straight line 101. Therefore, the sleeve 330 abuts against the shaft body 310 in the axial direction, abuts against the shaft body 310 in the radial direction based on the protrusion 331, and is stably sleeved on the shaft body 310 based on the first retainer 321 and the second retainer 322 so that the working accessory 400 can be stably clamped.

In some examples, as shown in FIG. 10, when the rear diameter D2 is less than the inner diameter D3 of the sleeve 330, the clamping device 300 further includes a positioning component 362. Along the direction of the first straight line 101, the positioning component 362 is disposed between the shaft body 310 and the sleeve 330, and in the up and down direction, the diameter of the positioning component 362 is greater than the inner diameter of the sleeve 330 so that the sleeve 330 includes an end in contact with the positioning component 362 along the direction of the first straight line 101. In this manner, when the rear diameter D2 of the shaft body 310 is too small to achieve the direct contact between the shaft body 310 and the sleeve 330 to ensure the stability of the sleeve 330, the positioning component 362 is used to achieve the indirect contact between the shaft body 310 and the sleeve 330 to ensure the stability of the sleeve 330. In addition, in this case, the inner diameter of the second elastic member 342 is greater than the inner diameter of the positioning component 362, that is, the inner diameter of the second elastic member 342 is greater than the front diameter D1 of the shaft body 310, and the same goes for the first elastic member 341. The details are not repeated here.

As shown in FIGS. 4 to 10, no matter what the relationship between the rear diameter D2 and the inner diameter of the sleeve 330 is, in the direction of the first straight line 101, no fixed connection structure exists between the sleeve 330 and the shaft body 310, and the sleeve 330 and the shaft body 310 are non-fixedly connected. Therefore, during assembly, the first retainer 321 and the second retainer 322 may be assembled into the shaft body 310, and then the sleeve 330 is sleeved on the shaft body 310 so that the circumferential surface of the sleeve 330 is smooth and has no holes. In this manner, the following disadvantages in the existing art are solved: the sleeve needs to be assembled to the shaft body before the retainers are mounted, the sleeve surface is provided with holes mating with the retainers, the sleeve manufacturing cost is relatively high, and the sleeve is not aesthetically pleasing.

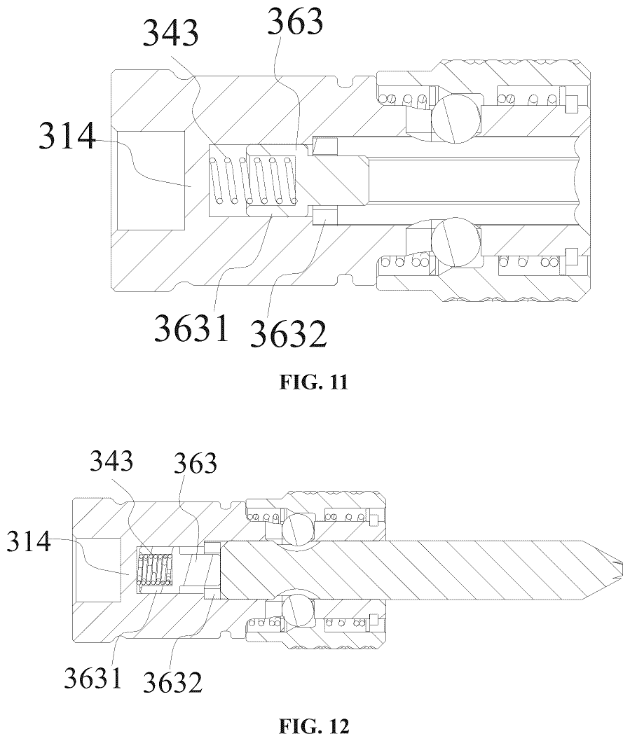

In some examples, the clamping device 300 further includes a third elastic member 343 disposed inside the shaft body 310 and used for mating with the working accessory 400. As shown in FIGS. 11 and 12, the third elastic member 343 is disposed inside the axial opening 311, and the left side of the third elastic member 343 is in contact with a shaft body limiting portion 314 inside the shaft body 310. Optionally, the third elastic member 343 may be fixedly connected to the shaft body limiting portion 314 and integrally formed with the shaft body limiting portion 314. Optionally, the third elastic member 343 may be provided separately from the shaft body limiting portion 314 and abut against the shaft body limiting portion 314, which is not limited in the present application.

A connection assembly 363 mating with the third elastic member 343 is disposed on the right side of the third elastic member 343. The connection assembly 363 includes a connection body 3631 and a connection guide portion 3632. The connection body 3631 can move relative to the connection guide portion 3632. The connection body 3631 surrounds the upper end, the lower end, and the right side of the third elastic member 343 and is used for compressing the third elastic member 343. The connection guide portion 3632 is disposed on the right side of the connection body 3631, and the connection guide portion 3632 is fixedly disposed inside the shaft body 310 and used for limiting the position of the working accessory 400. Optionally, the connection guide portion 3632 may be integrally formed with the shaft body 310, and a component protruding toward the inner side of the axial opening 311 and formed inside the shaft body 310 is the connection guide portion 3632. Optionally, the connection guide portion 3632 may be provided separately from the shaft body 310, and the connection guide portion 3632 may be formed separately and then fixed to the inside of the shaft body 310.

During the process of inserting the working accessory 400 into the axial opening 311, in addition to the preceding detailed description in the present application, the working accessory 400 abuts against the connection body 3631 in the direction of the first straight line 101 so that the connection body 3631 compresses the third elastic member 343 to the left, and the working accessory 400 compresses the third elastic member 343 based on the connection body 3631. The working accessory 400 moves to the left until the working accessory 400 is in contact with the connection guide portion 3632 and limited by the connection guide portion 3632. At this time, the two accessory grooves 410 of the working accessory 400 correspond to the two holes 312, respectively. That is, the width of the connection guide portion 3632 in the direction of the first straight line 101 is set based on the width that enables the accessory grooves 410 to correspond to the holes 312. In this manner, the first retainer 321 and the second retainer 322 fix the working accessory 400 inside the clamping device 300.

During the process of taking the working accessory 400 out of the axial opening 311, after the sleeve 330 is pulled axially, each of the first retainer 321 and the second retainer 322 is in a loose space between the sleeve 330 and the accessory groove 410 so that the third elastic member 343 applies an elastic force to the working accessory 400 to directly push the working accessory 400 to the right until the third elastic member 343 returns to an uncompressed state. At this time, the working accessory 400 is pushed away from the third elastic member, and the working accessory 400 still includes a portion located in the axial opening 311. However, the working accessory 400 is no longer fixed in the axial opening 311, and the user may loosen the sleeve 330 and remove the working accessory 400 from the axial opening 311. At this time, the user no longer needs to pull the sleeve 330 axially with one hand and pull the working accessory 400 outward with the other hand, and the user can pull the working accessory 400 out of the sleeve 330 with one hand.

In some examples, along the direction of the first straight line 101, the axial length of the sleeve 330 is greater than or equal to 13 mm and less than or equal to 20 mm. Optionally, the axial length of the sleeve 330 may be 14 mm. Optionally, the axial length of the sleeve 330 may be 16.4 mm. Optionally, the axial length of the sleeve 330 may be 17.4 mm. When the axial length of the sleeve 330 is relatively short, the second straight line 102 is perpendicular to the first straight line 101, and the third straight line 103 is perpendicular to the first straight line 101, that is, the protrusion 331 extends radially, and the abutting member 350 also extends radially.

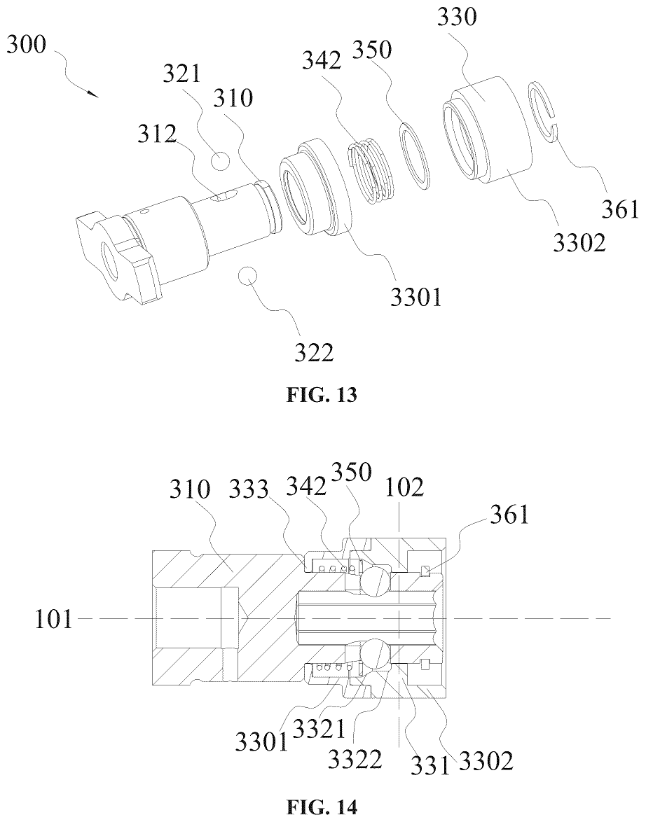

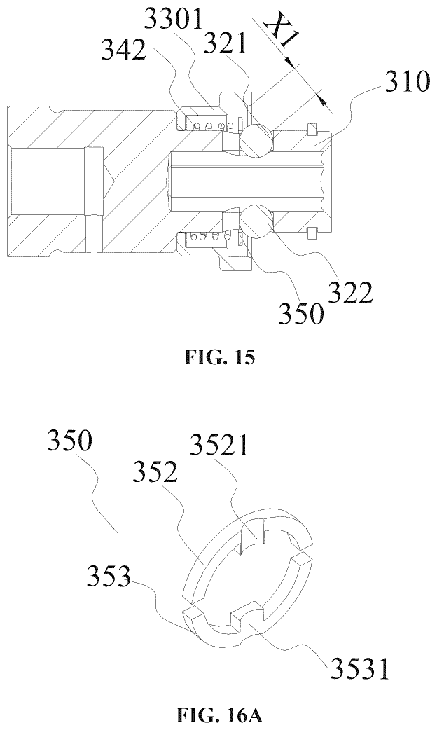

In some examples, as shown in FIGS. 13 to 15, the clamping device 300 includes only one elastic member 340, which is the second elastic member 342 disposed on the rear side of the retainers 320. The sleeve 330 includes a sleeve guide portion 333 fixedly connected to the sleeve 330, and the sleeve guide portion 333 extends along the radial direction perpendicular to the first straight line 101. The sleeve guide portion 333 is in contact with the shaft body 310 along the direction of the first straight line 101, and the second elastic member 342 is disposed between the sleeve guide portion 333 and the abutting member 350. The manner in which the abutting member 350 abuts against the first retainer 321 and the second retainer 322 to apply a force is the same as the manner described above in the present application, and the details are not repeated here.

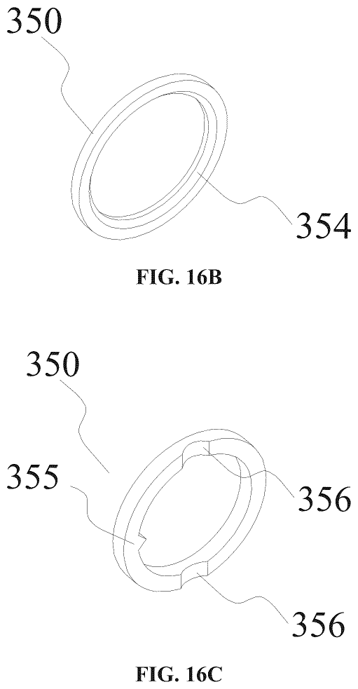

In some examples, the abutting member 350 may be a ring extending along the direction of the third straight line 103 as described above in the present application. In some examples, the abutting member 350 has a split structure. As shown in FIG. 16A, the abutting member 350 includes a first abutting member 352 and a second abutting member 353. The first abutting member 352 is an upper semicircular ring, and the second abutting member 353 is a lower semicircular ring. The first abutting member 352 includes a downward protrusion 3521 at a middle position, the second abutting member 353 includes an upward protrusion 3531 at a middle position, and the two protrusions are symmetrical to each other. When the abutting member 350 is sleeved on the shaft body 310, the protrusion 3521 and the protrusion 3531 are clamped in the corresponding two holes 312 to abut against the first retainer 321 and the second retainer 322, respectively. The protrusion 3521 and the protrusion 3531 each include an inner arc recess as shown in FIG. 16A so that the protrusion 3521 and the protrusion 3531 can better mate with the first retainer 321 and the second retainer 322 when abutting against the first retainer 321 and the second retainer 322.

In some examples, the abutting member 350 may have a ring structure as shown in FIG. 16B. In this case, a circle of chamfer 354 is provided inside the ring of the abutting member 350. Specifically, the case where the abutting member 350 abuts against the first retainer 321 and the second retainer 322 is that the chamfer 354 abuts against the first retainer 321 and the second retainer 322. Therefore, when the chamfer 354 is rounded, the chamfer 354 can better mate with the first retainer 321 and the second retainer 322.

In some examples, as shown in FIG. 16C, the abutting member 350 may include a guide structure 355 protruding toward the inside of the ring, and in this case, a guide groove matching the guide structure 355 is provided on the shaft body 310 so that the abutting member 350 can be directly sleeved on the shaft body 310 based on the cooperation between the guide structure 355 and the guide groove, thereby improving the accuracy of the sleeving position of the abutting member 350. As shown in FIG. 16C, the abutting member 350 further includes two vertically symmetrical concave ball grooves 356 mating with the first retainer 321 and the second retainer 322, respectively. Specifically, the case where the abutting member 350 abuts against the first retainer 321 and the second retainer 322 is that the ball grooves 356 abut against the first retainer 321 and the second retainer 322, respectively.

As shown in FIGS. 13 to 15, the clamping device 300 includes only one elastic member 340. When the working accessory 400 is not combined with the clamping device 300, the protrusion 331 of the sleeve 330 is located on the front sides of the first retainer 321 and the second retainer 322, the protrusion 331 abuts against the shaft body 310 along the direction of the second straight line 102, and the sleeve guide portion 333 abuts against the shaft body 310 along the direction of the first straight line 101. The horizontal surface 3322 of the stop portion 332 abuts against the first retainer 321 and the second retainer 322, and the horizontal surface 3322 mates with the holes 312 to prevent the first retainer 321 and the second retainer 322 from moving.

During the process of inserting the working accessory 400 into the axial opening 311, first, the working accessory 400 abuts against the first retainer 321 and the second retainer 322 toward the outside so that the first retainer 321 and the second retainer 322 are pressed and moved from the horizontal plane 3322 to the inclined plane 3321 in the axial direction. Moreover, during the process of being pressed and moved to the inclined plane 3321, the first retainer 321 and the second retainer 322 are pressed outward in the radial direction, the first retainer 321 is pressed and moved upward away from the hole 312, and the second retainer 322 is pressed and moved downward away from the hole 312. Next, when the working accessory 400 gradually moves toward the inside of the axial opening 311, the first retainer 321 and the second retainer 322 further press the inclined surface 3321 and the abutting member 350, that is, further press the inclined surface 3321 and the second elastic member 342, so that the second elastic member 342 is compressed between the abutting member 350 and the sleeve guide portion 333. Finally, after the working accessory 400 is fully inserted into the axial opening 311, the two accessory grooves 410 correspond to the two holes 312, respectively, the first retainer 321 and the second retainer 322 can no longer press the inclined surface 3321 and the second elastic member 342 based on the working accessory 400, the second elastic member 342 is released back to its original position, each of the first retainer 321 and the second retainer 322 is pushed to the right side to a position between the accessory groove 410 (or the hole 312) and the horizontal plane 3322 based on the elastic force, and the first retainer 321 and the second retainer 322 fix the working accessory 400 inside the clamping device 300.

During the process of pulling the working accessory 400 out of the axial opening 311, first, the sleeve 330 needs to be pulled axially. Specifically, the sleeve 330 needs to be pulled axially to the right. Moreover, due to the presence of the annular clamping member 361, after the sleeve 330 is pulled to the right until the sleeve 330 is in contact with the annular clamping member 361, the sleeve 330 is limited by the annular clamping member 361 and cannot be pulled any further. Specifically, the protrusion 331 is limited by the annular clamping member 361. Moreover, the sleeve guide portion 333 moves to the right synchronously, and the abutting member 350 abuts against the first retainer 321 and the second retainer 322 to remain stationary so that the sleeve guide portion 333 compresses the second elastic member 342 to the right. Next, based on the fact that the sleeve 330 moves to the right, the contact portion between the first retainer 321 and the sleeve 330 and the contact portion between the second retainer 322 and the sleeve 330 change from the horizontal plane 3322 to the plane behind the inclined plane 3321, in the up and down direction, each of the first retainer 321 and the second retainer 322 is in a loose space between the sleeve 330 and the accessory groove 410 and is no longer pressed and fixed so that the working accessory 400 can be pulled out of the axial opening 311. Finally, after the working accessory 400 is pulled out, the sleeve 330 is released, the second elastic member 342 is released back to its original position, and the sleeve 330 is pushed to the left based on the elastic force of the second elastic member 342 so that the sleeve 330 also returns to its original position.

In some examples, since the sleeve 330 includes the sleeve guide portion 333 fixedly connected to the sleeve 330, to avoid opening holes on the sleeve 330 to assemble the first retainer 321 and the second retainer 322 to the shaft body 310, the sleeve 330 may have a split structure. As shown in FIGS. 13 to 15, the sleeve 330 includes a first sleeve 3301 and a second sleeve 3302. An installation gap is formed between the first sleeve 3301 and the shaft body 310. The length X1 of the installation gap is greater than the diameter of the first retainer 321 (the second retainer 322). Therefore, the first retainer 321 and the second retainer 322 can be directly mounted on the shaft body 310 from the installation gap, and after the first retainer 321 and the second retainer 322 are mounted, the second sleeve 3302 is mounted on the first sleeve 3301. Optionally, the first sleeve 3301 and the second sleeve 3302 may be mounted by threads. Optionally, the first sleeve 3301 and the second sleeve 3302 may be mounted with an interference fit. In addition, the first sleeve 3301 and the second sleeve 3302 may be mounted in other manners, which are not limited in the present application.

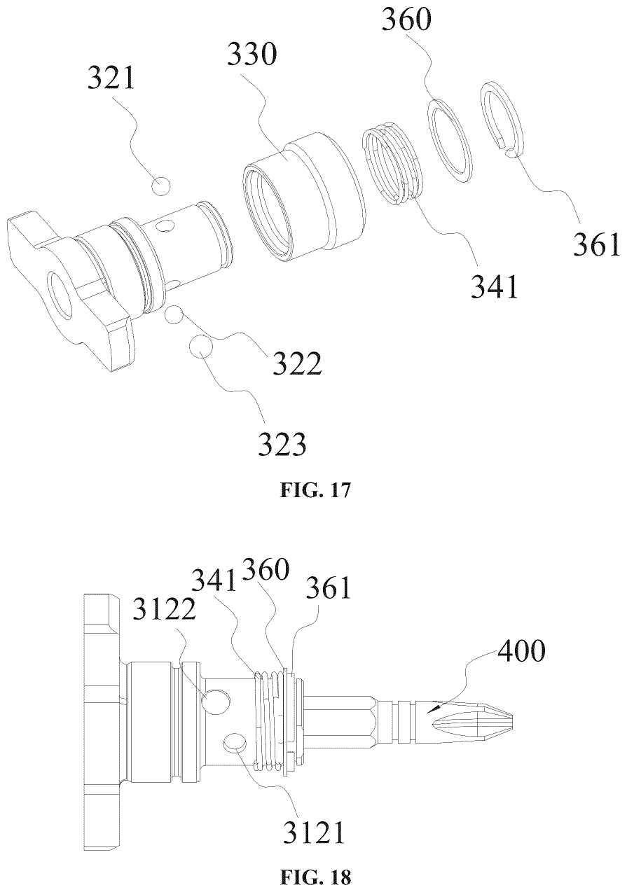

In some examples, as shown in FIG. 17, the retainers 320 further include a third retainer 323, and the diameter of the third retainer 323 is greater than the diameter of the first retainer 321 and the diameter of the second retainer 322, that is, the third retainer 323 is a sphere having a larger volume than the first retainer 321 and the second retainer 322. The holes 312 on the shaft body 310 include first holes 3121 for accommodating the first retainer 321 and the second retainer 322 and a second hole 3122 for accommodating the third retainer 323. The dimension of the second hole 3122 is greater than the dimension of the first hole 3121. The first hole 3121 and the second hole 3122 are both circular holes. Moreover, the inner diameter of the first hole 3121 matches the diameters of the first retainer 321 and the second retainer 322 so that the first retainer 321 and the second retainer 322 can be clamped in respective first holes 3121; and the inner diameter of the second hole 3122 matches the diameter of the third retainer 323 so that the third retainer 323 can be clamped in the second hole 3122. In addition, in some examples, the retainers 320 may include multiple retainers having the same sizes and positions as the third retainer 323 described below, that is, the retainers 320 include at least one third retainer 323.

The first holes 3121 and the second hole 3122 on the shaft body 310 are circular to replace the original elliptical holes, thereby facilitating machining and reducing the machining difficulty. Moreover, in the form of circular holes, the first retainer 321 and the second retainer 322 only move radially in the first holes 3121, and the third retainer 323 only moves radially in the second hole 3122 so that the length of the shaft body 310 can be reduced, thereby facilitating carrying and usage in a narrow space.

Optionally, along the direction of the first straight line 101, the center of the third retainer 323 may be located on the same straight line as the center of the first retainer 321 or the center of the second retainer 322. In this case, to prevent the shaft body wall of the shaft body 310 from being broken, a certain distance is required between the first hole 3121 and the second hole 3122. Optionally, along the direction of the first straight line 101, the center of the third retainer 323 may be located on a different straight line from both the center of the first retainer 321 and the center of the second retainer 322, that is, the third retainer 323 is rotated by a certain angle in the circumferential direction compared to the first retainer 321 or the second retainer 322. Along the direction of the first straight line 101, the projections of the first hole 3121 and the second hole 3122 partially overlap so that the length of the shaft body 310 along the direction of the first straight line 101 is relatively short. In this case, a certain distance is still required between the first hole 3121 and the second hole 3122 such that the thickness of the shaft body wall of the shaft body 310 is greater than or equal to 1 mm. Optionally, the thickness of the shaft body wall of the shaft body 310 may be 1.25 mm. Optionally, the thickness of the shaft body wall of the shaft body 310 may be 1.5 mm. Optionally, the thickness of the shaft body wall of the shaft body 310 may be 1.8 mm. Optionally, the thickness of the shaft body wall of the shaft body 310 may be 2 mm.

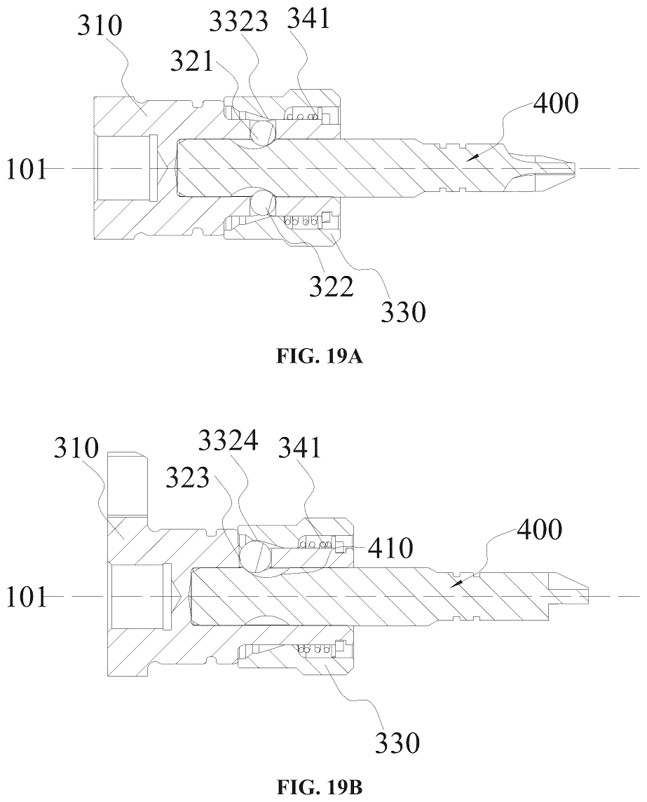

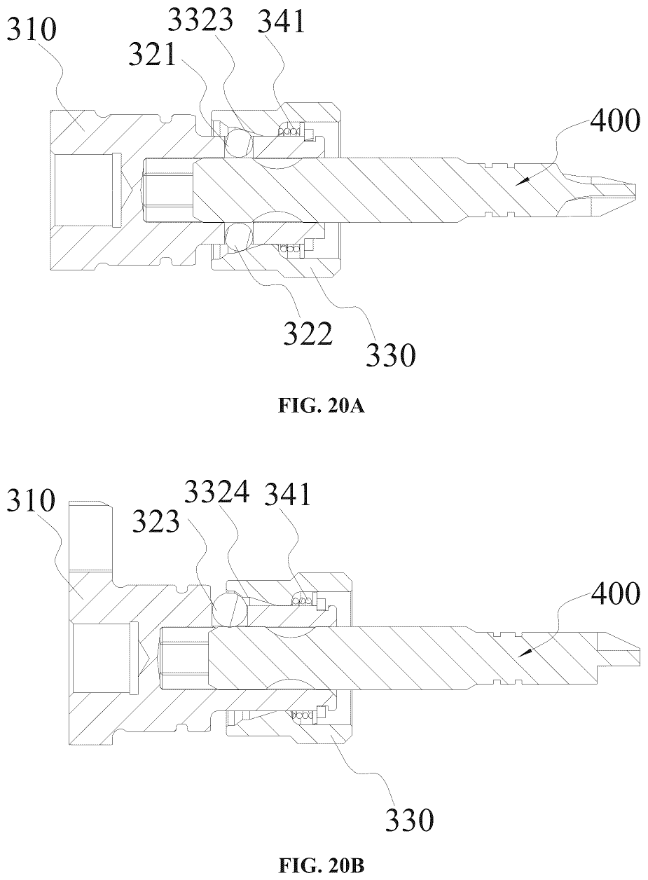

In some examples, as shown in FIGS. 17 and 18, the clamping device 300 includes only one elastic member 340, which is the first elastic member 341 disposed on the front side of the retainers 320. Moreover, the limiting portion 360 and the annular clamping member 361 are disposed on the front side of the first elastic member 341, and the first elastic member 341 is disposed between the limiting portion 360 and the protrusion 331 of the sleeve 330. As shown in FIGS. 19A to 20B, in this case, the stop portion 332 includes a second inclined surface 3323 and a second horizontal surface 3324.

When the working accessory 400 is inserted into the axial opening 311, the first retainer 321 and the second retainer 322 move outward to press the second inclined surface 3323 to move the sleeve 330. Specifically, under the action of the working accessory 400, the first retainer 321 and the second retainer 322 move outward along the radial direction of the shaft body 310 to press the second inclined surface 3323 of the sleeve 330 and then push the sleeve 330 to move forward toward the opening end of the axial opening 311. At the same time, the first elastic member 341 is compressed, and the first elastic member 341 is limited and compressed by the limiting portion 360. In this process, the third retainer 323 is in an unlocked state, and the third retainer 323 can move outward under the push of the working accessory 400, thereby facilitating the insertion of the working accessory 400.

When the working accessory 400 is inserted into the axial opening 311, the third retainer 323 moves inward and abuts against the accessory groove 410 to lock the working accessory 400. Specifically, when the working accessory 400 is inserted in place, the accessory groove 410 of the working accessory 400 is opposite to the third retainer 323, and the third retainer 323 automatically falls into the accessory groove 410, thereby locking the working accessory 400. Specifically, in this case, the first elastic member 341 pushes the sleeve 330 to be reset under the action of an elastic restoring force, and the second horizontal surface 3324 of the sleeve 330 abuts against the third retainer 323. Therefore, the third retainer 323 is restricted from moving in the radial direction of the shaft body 310, thereby locking the position of the working accessory 400 relative to the shaft body 310.

In this manner, the relative position between the working accessory 400 and the shaft body 310 can be locked, and during the subsequent operation of the working accessory 400, the working accessory 400 does not fall out of the shaft body 310, thereby ensuring the stability of operation of the impact screwdriver 100. In addition, in conjunction with FIGS. 19A and 19B, along the direction of the first straight line 101, the third retainer 323 is at least partially located behind the first retainer 321 and the second retainer 322 so that it can be ensured that the working accessory 400 is in contact with and mates with the first retainer 321 and the second retainer 322 and then is in contact with and mates with the third retainer 323, thereby ensuring that the mounting process of the working accessory 400 proceeds smoothly.

As shown in FIGS. 20A and 20B, when the working accessory 400 is pulled out of the axial opening 311 and the sleeve 330 is manually pulled, the first retainer 321, the second retainer 322, and the third retainer 323 can move radially so that the working accessory 400 can be pulled out. When the working accessory 400 needs to be replaced or removed, the operator manually pulls the sleeve 330 to move forward toward the opening end of the axial opening 311. At this time, the second horizontal plane 3324 is separated from the third retainer 323, the third retainer 323 is released from a locked state, the third retainer 323 is driven by the working accessory 400 to move outward along the radial direction of the shaft body 310, and the working accessory 400 is separated from the third retainer 323 so that the working accessory 400 can be pulled out smoothly. In this manner, the working accessory 400 is convenient to pull out, and the operation is simple.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A clamping device, comprising:
a shaft body having an axial opening, extending along a first straight line, for accommodating a working accessory and at least one hole disposed around a circumferential wall of the axial opening;
at least one retainer, wherein each of the at least one retainer is configured to move within a respective hole of the at least one hole;
a sleeve sleeved on an outer circumference of the shaft body and configured to move axially relative to the shaft body;
an abutting member abutting against a rear side of the at least one retainer;
a first elastic member disposed inside the sleeve and located on a front side of the at least one retainer; and
a second elastic member disposed inside the sleeve, located on the rear side of the at least one retainer, and being in contact with the abutting member;
wherein the sleeve comprises a protrusion extending along a second straight line, the protrusion abuts against the shaft body, the second straight line intersects with the first straight line, and, along a direction of the first straight line, the protrusion is located at a front end of the at least one retainer and is not in contact with the at least one retainer.

2. The clamping device of claim 1, wherein the abutting member extends along a third straight line and the third straight line intersects with the first straight line.

3. The clamping device of claim 1, wherein the sleeve comprises a stop portion, the stop portion comprises an inclined surface and a horizontal surface, and, when the working accessory is not inserted into the axial opening, the horizontal surface abuts against the at least one retainer.

4. The clamping device of claim 3, wherein, when the working accessory is inserted into the axial opening, the at least one retainer presses the inclined surface and the second elastic member.

5. The clamping device of claim 3, wherein the working accessory comprises at least one accessory groove, and each of the at least one accessory groove matches a respective retainer of the at least one retainer, after the working accessory is fully inserted into the axial opening, each of the at least one accessory groove corresponds to a respective hole of the at least one hole, and each of the at least one retainer is pushed to a position between a respective accessory groove of the at least one accessory groove and the horizontal plane based on an elastic force of the second elastic member.

6. The clamping device of claim 3, wherein, when the sleeve is pulled axially, the protrusion compresses the first elastic member so that the working accessory is capable of being pulled out of the axial opening.

7. The clamping device of claim 1, further comprising a limiting portion, wherein the limiting portion is disposed between the sleeve and the shaft body and located at a front end of the protrusion, and the first elastic member is disposed between the protrusion and the limiting portion.

8. The clamping device of claim 1, further comprising a third elastic member disposed inside the shaft body, wherein when the working accessory is inserted into the axial opening, the working accessory compresses the third elastic member.

9. The clamping device of claim 8, wherein, when the sleeve is pulled axially, the third elastic member applies an elastic force to the working accessory so that the working accessory is moved away from the third elastic member, and the working accessory is capable of being moved out of the axial opening.

10. The clamping device of claim 1, wherein, when a rear diameter of the shaft body is less than an inner diameter of the sleeve, the clamping device further comprises a positioning component, and the positioning component is sleeved on the shaft body.

11. The clamping device of claim 10, wherein an inner diameter of the second elastic member is greater than an inner diameter of the positioning component.

12. The clamping device of claim 10, wherein the sleeve comprises an end in contact with the positioning component along the direction of the first straight line.

13. The clamping device of claim 1, wherein each of the at least one retainer is a sphere.

14. The clamping device of claim 1, wherein along the direction of the first straight line, an axial length of the sleeve is greater than or equal to 13 mm and less than or equal to 20 mm.

15. The clamping device of claim 1, wherein the sleeve and the shaft body are non-fixedly connected, and a circumferential surface of the sleeve is smooth and has no holes.

16. A clamping device, comprising:
a shaft body having an axial opening, extending along a first straight line, for accommodating a working accessory and at least one hole disposed around a circumferential wall of the axial opening;
at least one retainer, wherein each of the at least one retainer is configured to move within a respective hole of the at least one hole;
a sleeve sleeved on an outer circumference of the shaft body and configured to move axially relative to the shaft body;
a first elastic member disposed inside the sleeve and located on a front side of the at least one retainer; and
a second elastic member disposed inside the sleeve and located on a rear side of the at least one retainer;
wherein the sleeve comprises a protrusion extending along a second straight line, the protrusion is located at a front end of the at least one hole and is in contact with the shaft body, the second straight line intersects with the first straight line, and the protrusion is not in contact with the at least one retainer along a circumferential circle around the shaft body.

17. A clamping device, comprising:
a shaft body having an axial opening, extending along a first straight line, for accommodating a working accessory and at least one hole disposed around a circumferential wall of the axial opening;
at least one retainer, wherein each of the at least one retainer is configured to move within a respective hole of the at least one hole;
a sleeve sleeved on an outer circumference of the shaft body and configured to move axially relative to the shaft body;
a first elastic member disposed inside the sleeve and located on a front side of the at least one retainer; and
a second elastic member disposed inside the sleeve and located on a rear side of the at least one retainer;
wherein the sleeve comprises a protrusion extending along a second straight line, the protrusion is in contact with the shaft body, no overlapping portion exists between a projection of the protrusion and a projection of the at least one hole on an axial plane, and the second straight line intersects with the first straight line.

18. The clamping device of claim 17, wherein projections of the at least one retainer and the at least one hole on the axial plane coincide.

19. The clamping device of claim 17, further comprising an abutting member abutting against the rear side of the at least one retainer, wherein the abutting member extends along a third straight line, the third straight line intersects with the first straight line, and the second elastic member abuts against the abutting member.

20. The clamping device of claim 19, wherein the sleeve comprises a stop portion, the stop portion comprises an inclined surface and a horizontal surface, and when the working accessory is inserted into the axial opening, the horizontal surface mates with the at least one retainer to prevent the working accessory to move.
